(19) United States
(12) Patent Application Publication
(10) Pub. No.: US 2018/0206643 A1
(43) Pub. Date: Jul. 26, 2018

(54) SEAT FITTING

(71) Applicant: DewertOkin GmbH, Kirchlengern (DE)

(72) Inventor: Andreas CEBULSKY, Wiehl (DE)

(21) Appl. No.: 15/746,007

(22) PCT Filed: Jul. 21, 2016
(86) PCT No.: PCT/EP2016/067433

§ 371 Date: Jan. 19, 2018

(30) Foreign Application Priority Data
Jul. 23, 2015 (DE) 20 2015 103 862.3

(51) Int. Cl. A47C 1/024; A61G 5/14; A47C 7/50

(52) U.S. Cl. CPC A47C 1/0242; A47C 7/506; A61G 5/14

(57) ABSTRACT

A seat fitting for seating furniture is provided, including a base frame, a sliding frame movably arranged relative to the base frame, and at least one linear drive which acts on a paired drive shaft in order to move a component or an assembly of the seat fitting, e.g., a foot part, a backrest part, or a stand-up aid, back and forth between an extended position and a retracted position relative to the base frame and/or the sliding frame. This allows a variable design and a retroactively simple adaptation on demand because the base frame, the sliding frame, the drive shaft, and the linear drive form a functional base unit which can be assembled in a modular manner to form a complete seat fitting with a foot part, a backrest part, a stand-up aid, and/or a seat frame provided for the sliding frame.

### CROSS-REFERENCE TO RELATED APPLICATIONS

This application is a Section 371 of International Application No. PCT/EP2016/067433, filed Jul. 21, 2016, which was published in the German language on Jan. 26, 2017, under International Publication No. WO 2017/013215 A1, which claims priority under 35 U.S.C. § 119(b) to German Application No. 20 2015 103 862.3, filed Jul. 23, 2015, the disclosures of which are incorporated herein by reference in their entirety.

### BACKGROUND OF THE INVENTION

The invention concerns a seat fitting for an article of seating furniture comprising a base frame, a sliding frame which is arranged moveably relative to the base frame and at least one linear drive which acts on an associated drive shaft for pivotal movement of a component or assembly of the seat fitting such as a foot portion, a backrest portion or a stand-up assist reciprocatively between an extended position and a retracted position relative to the base frame and/or the sliding frame.

Utility models DE 201 06 560 U1 and DE 202 00 499 U1 respectively disclose a completely pre-assembled seat fitting having motor-driven inclination adjustment of the backrest portion and the foot portion or having motor-driven height and depth displacement of the seat, wherein the structure and assembly thereof are complex in each case. In addition in the assembly procedure it is necessary to establish at the beginning how the seat fitting is to be designed.

### BRIEF SUMMARY OF THE INVENTION

Taking those disadvantages as its basic starting point, the object of the invention is to at least partially avoid those disadvantages and in particular develop a seat fitting of the kind set forth in the opening part of this specification such that it can be of a more variable design and can be easily retro-fitted as required.

The object of the invention is attained according to the invention by the features of the claims. Advantageous developments are set forth in the appendant claims. The specified object is already attained in that the base frame, the sliding frame, the drive shaft and the linear drive form a functional base unit which can be assembled in a modular structure to give a complete seat fitting having a foot portion, a backrest portion, a stand-up assist and/or a seat frame provided for the sliding frame.

According to an embodiment of the invention the base unit is so designed that it is functional. This means that the main components which are essential for movement of the component or components or assembly or assemblies of the seat fitting, such as the foot portion, the backrest portion, the seat frame or the stand-up assist, the linear drive with the drive shaft and the two frames with the base frame as a support structure and the sliding frame as a moving part, are pre-assembled to give the base unit. Here the linear drive includes further parts which are necessary for operation like lines and open-loop or closed-loop control means. In particular the functional base unit does not include a provided upholstery, as a simplification in terms of assembly. As described hereinafter, the upholstery can be subsequently clipped in place for example and can thus be also correspondingly easily replaced.

There is thus provided a modular structure in which, taking a base unit as the starting point, selected components or assemblies can be fitted thereto, in which case they can be varied according to applied demands such as customer-specific wishes, and can be altered again after assembly. The modules which are pre-assembled in a finished condition for assembly can also be kept in stock and delivered for the assembly procedure which considerably curtails the final assembly operation. The decision as to how actual designs are then to be made up and what functions they are to enjoy can thus be taken practically just before the final assembly operation. That modular structure can be implemented without any even only partial dismantling of the base unit.

It is further advantageous that the upholstery does not have to be subsequently fitted in place, as in the state of the art, which can be time-consuming and complicated because of the access for assembly to the locations involved, which is in part poor as it is tight and/or concealed. Rather, as described hereinafter, the upholstery can already be fitted in the pre-assembly operation of the respective component or assembly, in an assembly-friendly fashion. In that respect no consideration has to be given in particular to drives and the electric systems thereof having control means and power supply means, nor do they have to be at least partially integrated into the upholstery, as the necessary drives and electric systems are already pre-assembled in the base unit and are thus not part of the regions, which are to be upholstered, of the seat fitting of the article of seating furniture or the article of seating-lying furniture.

The individual components or assemblies can be arranged connected in torque-transmitting relationship to the respectively associated drive shaft. They can be connected to the base unit by way of connecting means, in particular by way of a lever arrangement or the coupling transmission driven by the respectively associated drive shaft.

Preferably at least one of the components or assemblies and in particular all thereof can be connected to the base unit by way of a releasable connection, in particular at least partially by way of a latching connection and here preferably by way of a latching/push-in connection. That facilitates final assembly and permits easy replacement of those components or assemblies.

In particular the individual components or assemblies can be respectively pre-fabricated to constitute a module. In particular for final assembly, they can be pre-fabricated in the form of modules already provided with the respectively associated connecting means.

In an embodiment of the seat fitting the drive shaft can serve as a transverse reinforcement for at least one of the frames.

The drive shaft can be mounted radially and axially non-displaceably rotatably to the frame.

The drive shaft or, when there are a plurality of linear drives, the drive shafts, can be arranged in the transverse direction of the base unit. It is preferably provided that the relative movements of the base frame relative to the sliding frame and those of the individual components or assemblies relative to the base unit takes place at least predominantly in a plane of movement perpendicularly to the transverse direction. Preferably that plane of movement is arranged perpendicularly to the transverse direction.

In particular it is provided that a substantially pure torque is transmitted by the drive shaft. Advantageously the drive shaft can be mounted to the frame in question in a flexural moment-free relationship or at least substantially in a flexural-free relationship. In that way it can be so arranged that it transmits at most a reduced flexural moment.

In an alternative way of attaining the object of the invention it can be provided that, as described hereinafter, the base frame and the sliding frame are respectively independent components. That has the advantage that the seat fitting can be of a more variable design configuration and can be easily retro-fitted as required. In particular the base frame and the sliding frame can be arranged moveably, in particular pivotably, relative to each other. That relative pivotal movement of the base frame and the sliding frame can take place in identical fashion, in particular uniformly and synchronously. In particular the parts of the base frame and/or those of the sliding frame can be moved uniformly and synchronously. Drive can be affected by way of an associated drive shaft. That counteracts twisting of the frames and stiffness of movement of the seat fitting, resulting therefrom. In particular the base frame and the sliding frame can be so arranged that due to the movement, in particular the pivotal movement, the sliding frame is moved in all its parts relative to all the parts of the base frame.

The linear drives described herein are displacement drives, in accordance with their function. As is known linear drives can be provided with a motor, in particular a rotational direction-reversible electric motor. A rotary speed reducing transmission can be provided at the drive output side relative to the motor. A linear drive train in the form of a threaded spindle-nut transmission can be arranged at the drive output side relative to the speed reducing transmission. The threaded spindle-nut transmission includes a slider which is linearly displaceably guided in a longitudinal direction and which is arranged connected to a drive output element by way of an operative connection in order to cause rotation of the drive output element here about the drive shaft upon linear displacement of the slider in the longitudinal direction. A torque can be applied to the drive shaft by way of the actuation of the drive output element.

In an advantageous embodiment the operative connection between the slider and the drive output element can include an interengaging tooth arrangement. For that purpose the drive output element can extend with a drive output portion in a transverse direction above the interengaging tooth arrangement. The interengaging tooth arrangement can be provided on an end portion of the slider, which is a lower end portion in the transverse direction.

In a structurally simple configuration, as an alternative to conversion of the linear movement produced by the linear drive into a torque, it is possible to provide a projection which projects radially from the drive shaft and is fixedly connected thereto and to which the linear drive is mechanically coupled at the drive output side. In particular the linear drive engages with its drive output element radially outwardly with respect to the associated drive shaft. Conversion of the linear movement into a torque can thus be effected by way of a projection which projects radially from the drive shaft and which is fixedly connected thereto and which is engaged by the linear drive at the drive output side eccentrically relative to the drive shaft, in particular radially outwardly on the projection.

The projection can also be fixedly and rigidly secured to the drive shaft and can be arranged to be actuatable by means of the drive output element, such as the free end of a threaded rod, of the linear drive. In particular the projection can be connected to the drive shaft in positively locking relationship, frictional locking relationship and adhesively bonded relationship. In that respect ultimately any known kinds of positively locking relationship can be considered. For example the drive shaft can be in the form of a round profile member, wherein the projection is arranged fixed to the drive shaft at a fixing location in respect of the drive shaft, for example by way of a pin, in particular a screw, which projects radially through the drive shaft and the projection or at least partially through each thereof.

For the purposes of adaptation to structure and application of the seat fitting the drive output element and its associated slider which is of a corresponding configuration can form an exchange assembly which is arranged exchangeably in relation to another exchange assembly. In that case, in the event of adaptation, the drive output element and the slider associated therewith of the other exchange assembly can be different from the drive output element and slider of the one exchange assembly. In the case of wear the other exchange assembly can have a drive output element and a slider which are equally or preferably more wear-resistant than the exchange assembly to be exchanged. For that purpose for example for adaptation and/or repair on site it is possible to provide kits having different exchange assemblies.

Alternatively such displacement drives can also be interpreted as a rotational drive as the displacement drive generates a rotary movement at the drive shaft although the displacement drive itself has a linear drive train. Other displacement drives have gear trains or epicyclic gears which also produce a rotating displacement movement at the drive shaft. Such displacement drives can also be referred to as rotational drives.

In an alternative way of attaining the object of the invention it can be provided that the displacement drive is arranged coupled directly to the base frame and to the sliding frame. In particular the displacement drive can engage the base frame at a first connection point and the sliding frame at a second connection point. In operation of the displacement drive the two connection points can move relative to each other. That involves a movement of the sliding frame relative to the base frame. At least one of the connection points can be for example in the form of a fork head or fork joint or ball joint.

Particularly in this alternative configuration the drive shaft can be provided having the direct coupling. That can preferably have at least one rotary lever which is fixedly fitted in particular for each sliding frame side portion and the respective free end of which is connected in mechanically coupled relationship to the respective sliding frame side portion. All elements of the sliding frame and same in turn can be moved and in particular displaced in a uniform and synchronous movement relative to the base frame by the drive shaft.

For freedom in respect of flexural moment of the drive shaft it can be provided that the flexural moments occurring upon conversion of the linear movement produced by the linear drive into a torque acting on the drive shaft are carried substantially perpendicularly to the longitudinal extent of the drive shaft by a mounting means of the drive shaft to the housing.

In particular the at least one linear drive can have a housing through which the associated drive shaft is guided and mounted thereto radially, in particular radially-axially. In a development of the seat fitting the housing can be of a reinforced configuration for carrying flexural moments exerted on the drive shaft by the linear drive.

In particular the housing can have a reinforcement. In a structurally simple configuration it is possible to provide laterally reinforcing flanges. They can engage over the housing at the end and in particular can embrace it in clip-like relationship. In that way at least the predominant part of the flexural moments exerted on the drive shaft by the linear drive can be carried by the housing. In that way the drive shaft can correspondingly serve at least predominantly for the transmission of a torque which ultimately is transmitted to the associated component or the associated assembly. That measure makes it possible for the frame to which the drive shaft is mounted to be subjected to the minimal loading so that it only has to be of a corresponding simple configuration.

In a further advantageously simple configuration of the seat fitting it can be provided that the base frame of the seat fitting has two base frame side portions and, arranged between them, a transverse reinforcement, in particular a transverse member or a transverse strut means, in that case the base frame side portions can be arranged perpendicularly to the transverse direction.

In a further simplification of the seat fitting the sliding frame can include two sliding frame side portions which are mounted moveably relative to the base frame on same. In particular the sliding frame side portions can be pivotably mounted to the base frame side portions, in particular with respect to a plane perpendicularly to the transverse direction. Advantageously in regard to simplicity of structure, it is possible to dispense with further sliding frame portions like the transverse member for the sliding frame. Stabilization of the sliding frame however, as described hereinafter, can be achieved by an additional drive shaft for a provided backrest portion and/or for fitting a seat frame on the sliding frame.

The base frame side portions can be arranged connected and in mutually spaced relationship in the transverse direction by means of the transverse member or the transverse strut means. As the drive shafts can serve at the same time as the transverse strut means no further sliding frame portions are necessary. The sliding frame side portions can be arranged laterally beside the base frame side portions in a desirable fashion in terms of the mechanical forces involved. In that way the transverse reinforcement and the drive shaft or, when there are a plurality of linear drives, the drive shafts, can additionally serve to stiffen the sliding frame and space the sliding frame side portions in the transverse direction.

At least one of the drive shafts can be mounted rotatably engaging into a respective jaw-like mounting opening provided on a frame side portion, preferably in latching relationship at both ends. For latching the drive shaft in the mounting opening same can be of a slot-like configuration having a narrowing at the entry end with respect to the radial engagement direction of the drive shaft. That narrowing can be somewhat smaller, preferably a few tenths of a millimeter smaller, than the outside diameter of the associated drive shaft. The jaw-like mounting opening can be inclined in a direction perpendicularly to the seat plane and opened in the heightwise direction. In a development the drive shaft can be in the form of a hollow shaft guided on a radially inwardly disposed axis member. Preferably the axis member is fixedly connected to the associated frame.

In a development of the seat fitting it is provided that the base frame side portions and/or the sliding frame side portions are of a plate-shaped configuration. They can extend desirably in terms of mechanical forces involved with their planes transversely and preferably in the retracted position of the seat fitting in particular perpendicularly to the seat plane.

The base frame side portions and/or the sliding frame side portions can be respectively designed as an assembly plate. In particular all openings and mountings which are necessary for mounting the individual modules like the backrest portion, the foot portion, the stand-up assist and/or the seat frame can already be provided on the assembly plate.

In a further configuration of the seat fitting as a simplification thereof the at least one linear drive can be arranged on the sliding frame in counter-mounted relationship. In that way it is possible to achieve further stiffening of the sliding frame and in particular the backrest portion. Preferably the at least one linear drive is arranged in flange-mounted relationship, in particular pivotably, laterally to one of the sliding frame side portions.

In particular the linear drives can be connected to the sliding frame side portion for movement of the backrest portion and the foot portion.

A development of the seat fitting can provide that insofar as the foot portion, the backrest portion and/or the stand-up assist are provided in the complete seat fitting, associated with the foot portion or the sliding frame is a linear drive which is in the form of a sliding frame linear drive and acts on a drive shaft in the form of a sliding frame drive shaft, associated with the backrest portion is a linear drive which is in the form of a backrest linear drive and which acts on a drive shaft in the form of a backrest drive shaft, and/or associated with the stand-up assist is a linear drive which is in the form of a stand-up assist linear drive and which acts on a drive shaft in the form of a stand-up assist drive shaft.

In particular the sliding frame is held pivotably to the base frame at its sliding frame side portions by way of pivot levers. In particular the pivotal movement can be implemented by way of pivot levers pivotably connecting sliding frame side portions and base frame side portions.

It is desirable in regard to stability if a base frame side portion can be associated with each sliding frame side portion. The sliding frame side portion and the base frame side portion are arranged in mutually paired relationship, constituting a side portion pair. They can advantageously easily be arranged pivotably coupled by way of pivot levers. In particular the pivot levers together with the sliding frame drive shaft and the frame side portions which are associated with each other in paired relationship can form a coupling transmission, in particular a crank rocker mechanism which is not capable of full rotation. That applies for each pair of side portions, wherein the coupling transmission or the crank rocker mechanism of each pair of side portions is of an identical configuration which is advantageous in terms of structure and mechanical configuration. Advantageously the pivotal movement of the members of the individual crank rocker mechanisms can be effected driven by the same drive shaft, in particular the same sliding frame drive shaft. That ensures the above-mentioned uniform synchronous relative pivotal movement of the frames, that is to say the base frame and the sliding frame.

In an advantageously simple development two pivot levers can be provided for each sliding frame side portion. The pivot levers together with the sliding frame drive shaft and the frame side portions associated with each other in pairs form a four-member first coupling transmission which is driven by way of the sliding frame drive shaft. The pivotal movement can occur in a plane of movement perpendicularly to the transverse direction. In a configuration which simplifies the structure of the seat frame the two pivot levers associated with a sliding frame side portion can be arranged pivotably with one end at the respective sliding frame side portion. At the other end thereof a pivot lever can be at least non-rotatably mounted to the sliding frame shaft and the other pivot lever can be mounted pivotably to the base frame, in particular to the base frame side portion associated with that sliding frame side portion. Preferably the pivot levers are not arranged in mutually parallel relationship. They can be arranged to diverge conically upwardly in the heightwise direction in such a way that the sliding frame with its movement into the extended position is moved at the first side assigned to the foot portion in a heightwise direction.

The foot portion can be held moveably, in particular pivotably and/or displaceably, relative to the base unit. Promoting a compact structure the sliding frame drive shaft can be arranged at the first side of the base unit, that is associated with the foot portion.

In particular the foot portion can be connected on the one hand to the sliding frame and on the other hand to the base frame by way of a scissor-like lever arrangement at the first side of the base unit. The foot portion can be pivotably connected to the associated sliding frame side portion and the associated base frame side portion. With the displacement of the sliding frame relative to the base frame the foot portion can be reciprocatingly displaced relative to the frames by way of the scissor-like lever arrangement between the extended position in which the foot portion is arranged approximately at the height of the seat plane, and a retracted position in which the foot portion is arranged displaced below the base frame. A scissor-like lever arrangement can be provided for each side portion. The foot portion can be connected to the lever arrangement by means of a push-in connection, in particular a push-in/latching connection. In particular the foot portion and the scissor-like lever arrangement can be prefabricated in the form of a module according to the modular nature of the arrangement.

In a development of the seat fitting it can be provided that the backrest portion is arranged held moveably, in particular pivotably, preferably directly to the base unit, in particular to the sliding frame. Advantageously by virtue of a compact structure the backrest portion drive shaft can be arranged at the second side of the sliding frame, that is remote from the foot portion. The backrest portion can be non-rotatably connected directly to the backrest portion drive shaft. Directly means without a lever arrangement or transmission-connecting members, disposed therebetween. To facilitate assembly, it is possible to provide preferably at both sides on the backrest portion drive shaft a respective connecting portion fixedly connected thereto. The backrest portion can be connected to the connecting portion by means in particular of a push-in or push-in/latching connection.

In that way the foot portion but also the backrest portion can be easily assembled or exchanged.

In a further embodiment of the seat fitting it is possible to provide, for implementing the stand-up assist, a base support at which the base unit is arranged held moveably, in particular in the plane of movement. The base support can be arranged in posterior relationship with the base frame in respect of a sequence of movements beginning at the sliding frame. Extension of the stand-up assist can predominantly signify lifting the base frame together with the sliding frame or lifting the base unit.

For extension and retraction of the base frame with actuation of the stand-up assist linear drive with a stand-up assist drive shaft together with the sliding frame relative to the base support, it is possible to provide connecting elements. In particular they can be parts of a lever arrangement. That lever arrangement can operate kinematically to communicate movement and travel with respect to the frames in themselves and/or between the frames and the base support.

In particular the lever arrangement for the stand-up assist can be in the form of a multi-member planar coupling transmission, in particular a five-member or seven-member second coupling transmission. That can also form a crank rocker mechanism which is not capable of full rotation. In particular the base support and the lever arrangement can be prefabricated in the form of a module in accordance with the modular structure involved. In particular a second coupling transmission which engages each base frame side portion can be associated therewith. The then at least two second coupling transmissions are driven in the same fashion, with the same effect and at the same time, which is advantageous in terms of the mechanical forces involved.

The base support or, if same is not provided, the base frame, can be adapted to be dockable in the usual manner, preferably rotatably, to a support leg or the framework of an article of seating furniture.

The base frame can define a receiving space. Advantageously in terms of a compact structure, the sliding frame, the at least one linear drive and the associated drive shaft can be arranged in the receiving space. In addition all linear drives h the associated drive shafts can be arranged in the receiving space.

In a development of the seat fitting the seat frame can be arranged held to the sliding frame above the sliding frame in the heightwise direction. The seat frame can be arranged releasably on the sliding frame. The seat frame can define a seat plane. The seat plane can be displaced in parallel relationship with extension of the seat frame which is connected to the sliding frame. In particular the seat plane can be raised by way of the stand-up assist and/or pivoted about a pivot axis which is arranged parallel to the transverse direction of the fitting and in a central region with respect to the longitudinal direction.

In a simplified embodiment of the seat fitting the base unit can be provided only with the stand-up assist with associated drive to produce a stool or a stool-like article of seating furniture. That seat fitting can be used in particular in the sanitary area to be able to lift a patient for example for treatment. In that respect it can preferably be optionally provided that lifting of the seat plane in the heightwise direction takes place in the form of a parallel displacement, in particular by way of a parallel guide means. It is also possible to provide for inclination of the seat plane towards the first side of the base unit, which inclination preferably increases with the displacement of the seat plane in the heightwise direction upwardly.

In an alternative way of attaining the above-specified object there can be provided an article of seating furniture having the seat fitting in accordance with one of the configurations described hereinbefore and/or hereinafter.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

The present invention is described in greater detail hereinafter by means of a number of preferred embodiments of the guide arrangement as illustrated in a drawing. These serve to illustrate specific embodiments in which the invention can be carried into effect. In this respect the directional terminology like for example “upward”, “downward”, “forward”, “rearward”, “front”, “rear” and so forth is used in relation to the orientation of the described Fig. or Figs. As components of embodiments can be positioned in a number of different orientations the directional terminology serves for illustration and is in no way limiting. It will be appreciated that other embodiments can be used and structural or logical modifications can be made without thereby departing from the scope of protection of the present invention. The following specific description is not to be interpreted in a limiting sense. In the context of this description the term “connected” is used to describe both a direct and also an indirect connection. Identical or similar components are denoted by identical references in the Figs. insofar as that is desirable. The representations in the Figs. are substantially true to scale. In addition the drawings can be simplified for improved clarity and do not contain every detail which is possibly present in a practical configuration.

In the drawings:

FIG. 1 shows a perspective view of a first configuration of an article of seating furniture with a seat fitting having a base unit, in a retracted position,

FIG. 2 shows a perspective view of the article of seating furniture in an extended position,

FIG. 2A shows a portion IIa as shown in FIG. 2,

FIGS. 3A and 3B respectively show a perspective view of the base unit of FIG. 1 with connecting means on a backrest portion drive shaft in the retracted position and in an extended position,

FIGS. 4A and 4B each show a perspective view of a base unit having a stand-up assist in the retracted position,

FIGS. 5A and 5B each show a perspective view of the enlarged base unit of FIGS. 4A and 4B with the stand-up assist in the extended position, and

FIGS. 6A and 6B each show an identical view of a further embodiment with the enlarged base unit of FIGS. 5A and 5B but with components being omitted.

### DETAILED DESCRIPTION OF THE INVENTION

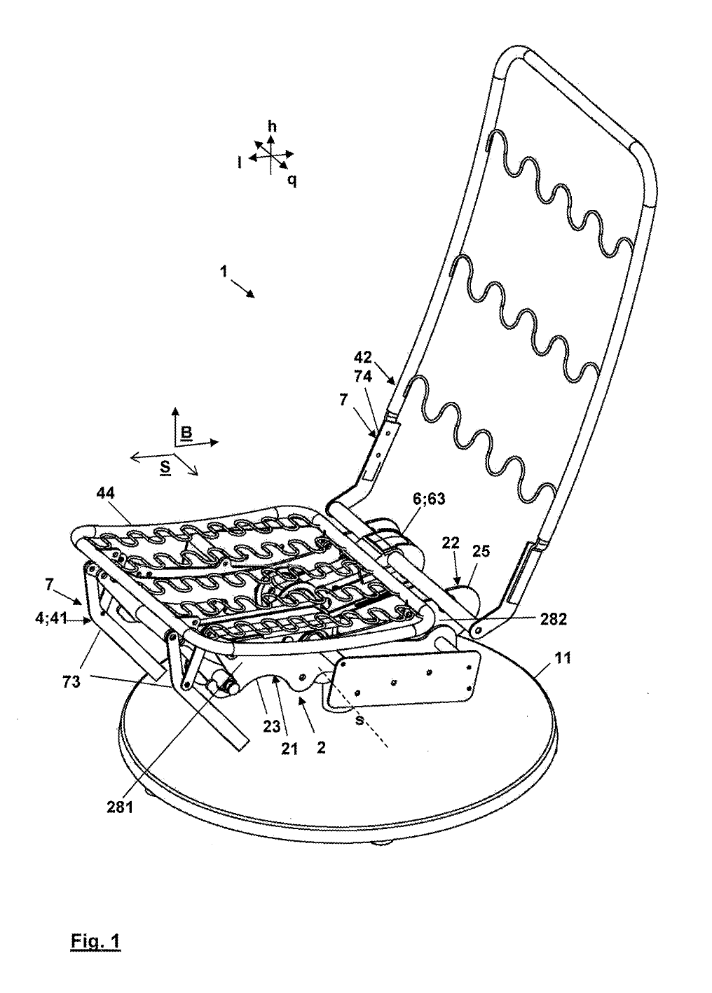

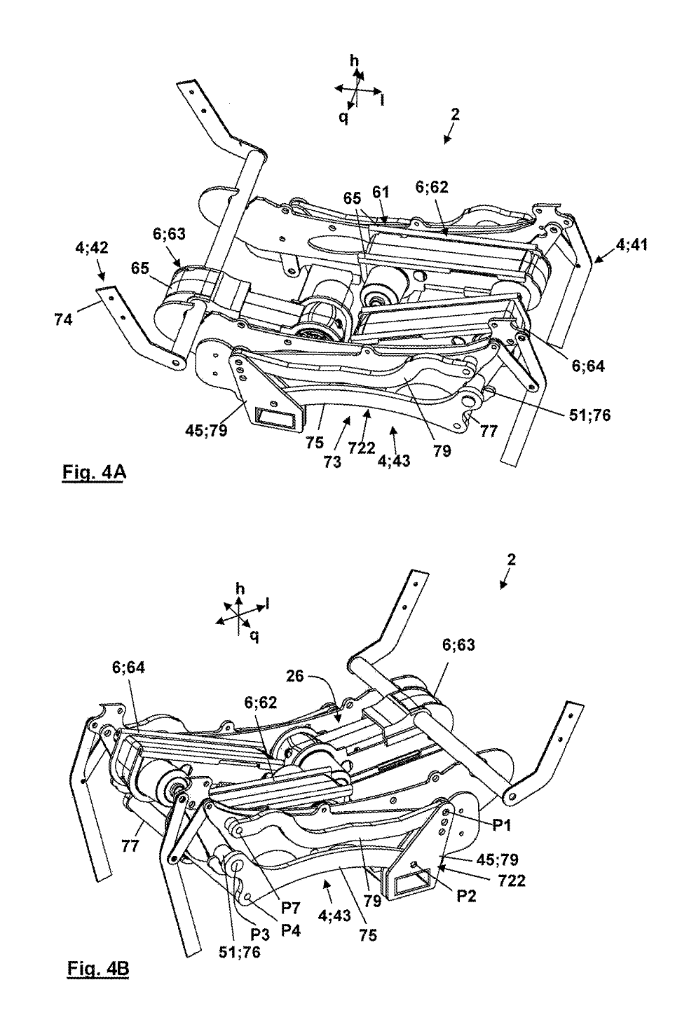

FIGS. 1, 2 and 6 respectively show a view of an embodiment of an article of seating furniture 1 comprising a seat fitting 3 having a functional base unit 4, but without upholstery, while FIGS. 3 through 5 each show a perspective view of an embodiment of the base unit 2 in part with attached further modules 4.

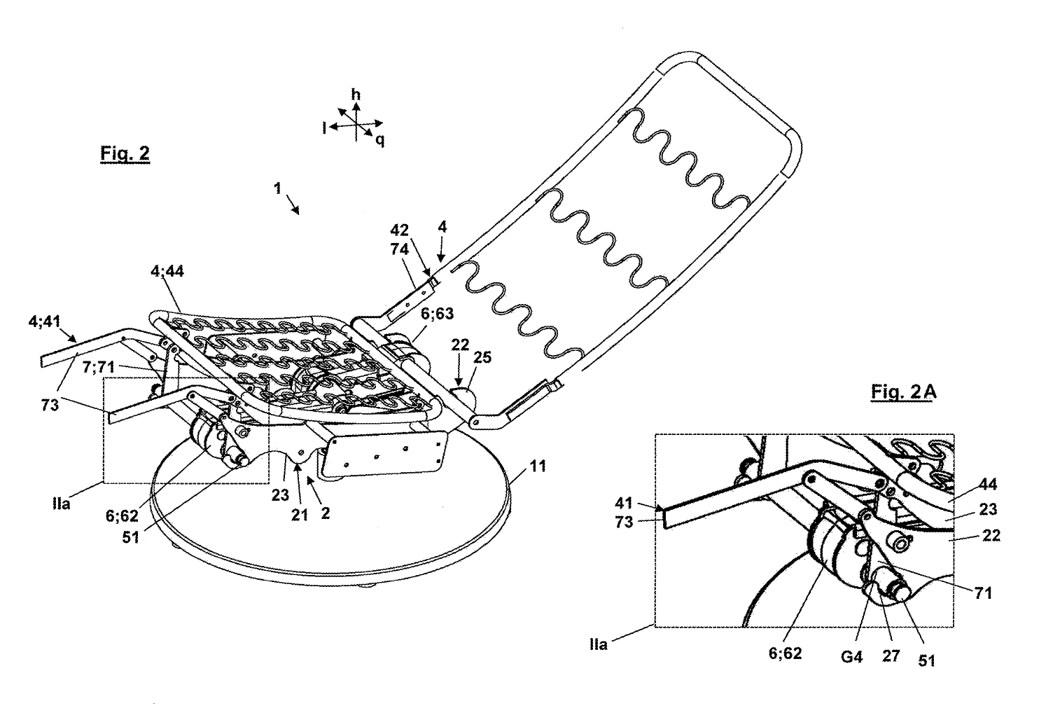

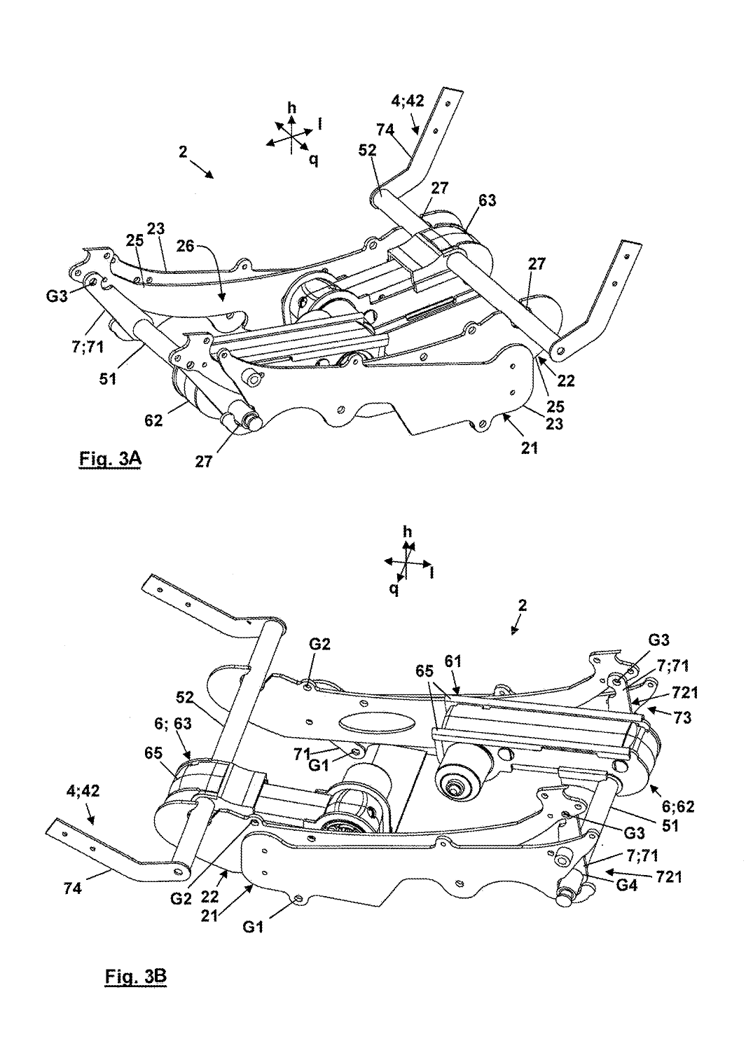

The base unit 2 has a base frame 21, a sliding frame 22 arranged moveably relative to the base frame 21 and at least one linear drive 6 acting on an associated drive shaft 4 for reciprocating movement of a component or a assembly of the seat fitting 3 such as a foot portion 41, a backrest portion 42 and a stand-up assist 43, between an extended position (FIGS. 2, 3B and 5) and a retracted position (FIGS. 1, 3A and 4) relative to the frame 21, 22. The movement of the components or assemblies and that of the sliding frame relative to the base frame 21 respectively is effected here exclusively in a plane of movement B perpendicularly to a transverse direction q of the seat fitting 3. The base frame 21, the sliding frame 22, the drive shaft 5 and the linear drive 6 form the functional base unit 2. As shown hereinafter the base unit 2 can be assembled in a modular structure to afford a complete seat fitting having foot portion 41, backrest portion 42, stand-up assist 43 and/or a seat frame 44 which is arranged above the sliding frame 22 and has a seat plane S. No dismantling, even only partial, of the base unit 2 is required for that assembly operation.

The base frame 21 has two base frame side portions 23 and transversely thereto a transverse member 24 which connects the base frame side portions 23 together in mutually spaced relationship. The sliding frame 22 is made up of two sliding frame side portions 25 which are mounted moveably relative to the base frame 21 to the base frame, whereby the base frame 21 is mechanically stabilized and reinforced.

The base frame 21 defines a receiving space 26 in which the sliding frame side portions 25 are arranged laterally at the base frame side portions and at the inside thereof the linear drive or drives 6.

The linear drives 6 each have a respective housing 61, through which or on which the respectively associated drive shaft 5 is guided or mounted non-displaceably axially and radially in a radial-axial mounting. In addition the drive shaft 5 or drive shafts 5 extends or extend in the transverse direction q through the receiving space 26, being respectively mounted rotatably to one of the frames 21, 22. The linear drives 6 respectively engage with a drive end at the associated drive shaft 5 and are respectively mounted pivotably to the base frame 21 by way of their housing 61. That provides a particularly compact structure for the base unit 2. In addition drive shafts 5 and linear drives 6 enhance the strength, in particular the torsional strength of the base frame 21 and thus that of the base unit 2. The housing 61 of the linear drives 6 is also reinforced insofar as it has as reinforcement means additional lateral stiffening flanges 65 (FIG. 3B). Those lateral stiffening flanges 65 reinforce the wall of the housing 61 in particular at the locations at which the drive shaft 5 is guided through the housing 61 and mounted to the housing 61. That makes it possible for the drive shaft 5 to be so mounted in the radial-axial mounting that by way thereof flexural forces which due to conversion of the linear movement of the linear drive 6 into a rotary movement act substantially perpendicularly on the drive shaft 5 are at least predominantly carried by the housing 61. That means that substantially a pure torque is transmitted by the drive shaft 5 so that, in contrast to the state of the art, the respective frame 21, 22 to which the drive shaft 5 is mounted is only slightly loaded as only slight flexural moments are transmitted to the frame 21, 22, if at all, by way of the mounting of the drive shaft 5. Accordingly the drive shaft 5 can be mounted with a low level of friction in a plain bearing (not further shown here) with a sliding bearing sleeve on the frame 21, 22. That further contributes to the base unit 2, in spite of its very simple structure with few elements, enjoying a strength which is sufficient for operation of the arrangement, in particular flexural stiffness and torsional stiffness.

The base frame side portions 23 and the sliding frame side portions 25 are of a plate-shaped configuration, wherein they extend with their planes here approximately perpendicularly to the seat plane S and perpendicularly to the transverse direction q and the longitudinal direction l of the respectively associated frame 21, 22. As can also be clearly seen in particular from FIGS. 3 through 6 the plate-shaped base frame side portions 23 and sliding frame side portions 25 are respectively designed in the form of an assembly plate insofar as all openings and mountings required for assembly of the individual modules 4 are already provided in the plate. This means that, for final assembly of the seat fitting, there is no need for any further operations on the frame side portions 23, 25.

Insofar as a foot portion 41, a backrest portion 42 and/or a stand-up assist 43 are provided in the complete seat fitting 3, in general terms a linear drive 6 in the form of a sliding frame linear drive 62 is associated with the foot portion 41, which drive exerts a torque on a drive shaft 5 in the form of a sliding frame drive shaft 51. In addition, associated with the backrest portion 42 is a linear drive 6 in the form of a backrest portion linear drive 63, which acts on a drive shaft 5 in the form of a backrest portion drive shaft 53. Finally, associated with the stand-up assist 43 is a linear drive which is in the form of a stand-up assist linear drive 64 and which acts on a drive shaft 5 in the form of a stand-up assist drive shaft 53. As a simplification in the base unit 2 however all linear drives 6 are of an identical structure in the embodiments of the seat fitting 3 which are shown here.

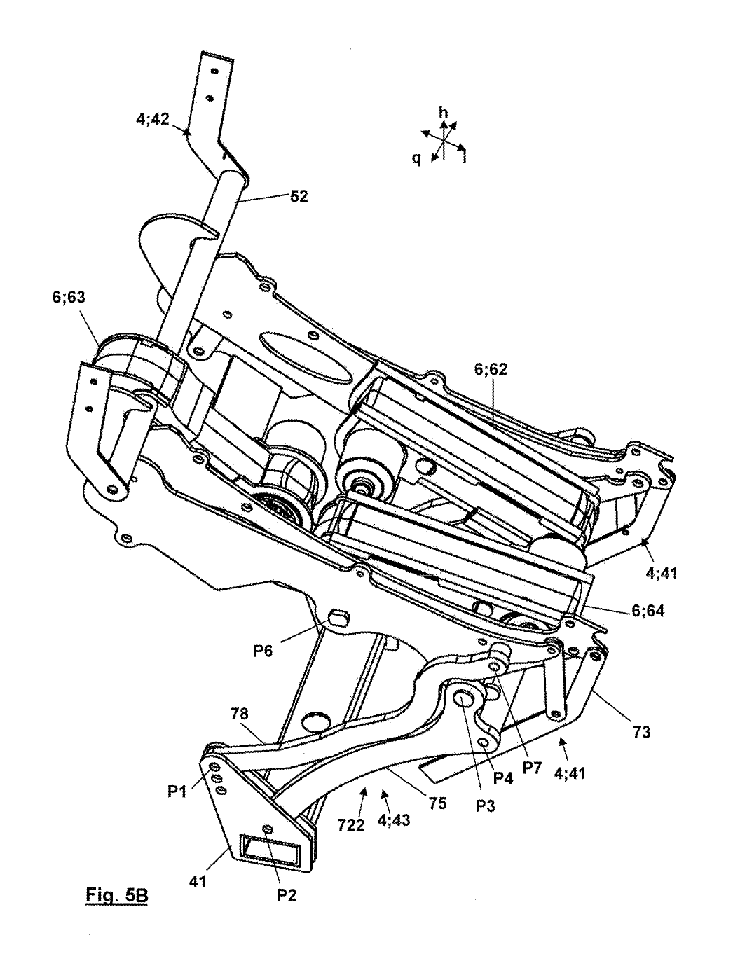

In contrast, in the embodiments of the seat fitting 3 shown here the drive shafts 5 are of differing configurations: the sliding frame drive shaft 51 and the backrest portion drive shaft 52 are respectively in the form of solid shafts which are rotatably mounted in a latching mounting means 27 in the respectively associated frame 21, 22, wherein the latching mounting means 27 is of an open configuration substantially in a heightwise direction h. In this case the drive shaft 5 respectively projects laterally outwardly beyond the associated frame 21, 22 (see FIG. 3). In contrast, as can be seen from FIG. 5A, the stand-up assist drive shaft 53 is of a two-part configuration insofar as it has an inner support axis member 54 which is fixedly connected to at least one base frame side portion 23. A hollow shaft 55 is radially-axially mounted on the support axis member 54 between the base frame side portions 23 and is driven by the stand-up assist linear drive 64.

For final assembly the modules 4 are here respectively provided with the connecting means 7 necessary for connection to the base unit 2, wherein the connecting means 7 are of differing configurations in dependence on their function.

In detail the sliding frame 22 is held at the sliding frame side portions 25 pivotably relative to the base frame 21 by way of pivot levers 71. Provided for each sliding frame side portion 25 is a pair of levers comprising two pivot levers 71 which together with the sliding frame drive shaft 51 and the associated base frame side portion 23 form a four-member first coupling transmission 721, which here is planar, having four joint points G1-G4 (see FIG. 3B, wherein for greater clarity of illustrating the structure a pivot lever at the front between G1 and G2 has been omitted). That first coupling transmission 721 is driven by way of the sliding frame drive shaft 51. A base frame side portion 23 is associated with each sliding frame side portion 25. Accordingly the seat fitting 3 here has two first coupling transmissions 721 which are of an identical configuration and are driven by way of the same sliding frame drive shaft 51. Accordingly the pivotal movement of the sliding frame side portions 51 relative to the base frame side portions 23 is effected in identical, uniform and synchronous fashion.

The two pivot levers 71 of a pair of levers diverge upwardly. That therefore affords a rocker structure, in accordance with which, in the extended position of the foot portion 41 (FIG. 2), the first side 281 of the sliding frame 22, that is adjacent to the foot portion 41, is set higher relative to the base frame 21 in the retracted position (FIG. 1) as in the extended position the pivot lever 71 associated with the first side 281 is disposed vertically.

The foot portion 41 is pivotably connected by way of a scissor-like lever arrangement 73 at the first side 281 of the base unit 2 on the one hand to the sliding frame 22 and on the other hand to the base frame 21. As can be seen from FIGS. 1 and 2 the foot portion 41 in the extended position is disposed approximately at the height of the seat plane S while in the retracted position it is arranged displaced under the base frame 21. For each side portion 23, 25 there is a scissor-like lever arrangement 73 which are arranged in mutually spaced relationship in the transverse direction q. The foot portion 41 is connected to the two lever arrangements 73 by means of a push-in/latching connection.

The backrest portion 42 is here fixedly connected to the backrest portion drive shaft 52 by way of angle portions 74. Similarly to the sliding frame drive shaft 51 the backrest portion drive shaft 52 is mounted here to the sliding frame side portions 25 by way of jaw-shaped latching mountings 27. The angle portions 74 are fixedly connected to the backrest portion drive shaft 52 at the ends, the sliding frame drive shaft 51 projecting laterally in the transverse direction q beyond the frames 21, 22.

As shown in FIGS. 1 and 2 the seat frame 44 is mounted on the sliding frame 22, with the seat frame 44 projecting forwardly and laterally beyond the frames 21, 22. However no further component engages the seat frame 44 so that the seat frame 44 is mechanically non-loaded, apart from its own weight and the weight of a user (not shown here). As the seat frame 44 can be fitted in the form of a module it can be previously completely prefabricated with possible upholstery (not shown here). Both, the slight mechanical loading and the possible option of prefabrication, also apply to the backrest portion 42 and the foot portion 41.

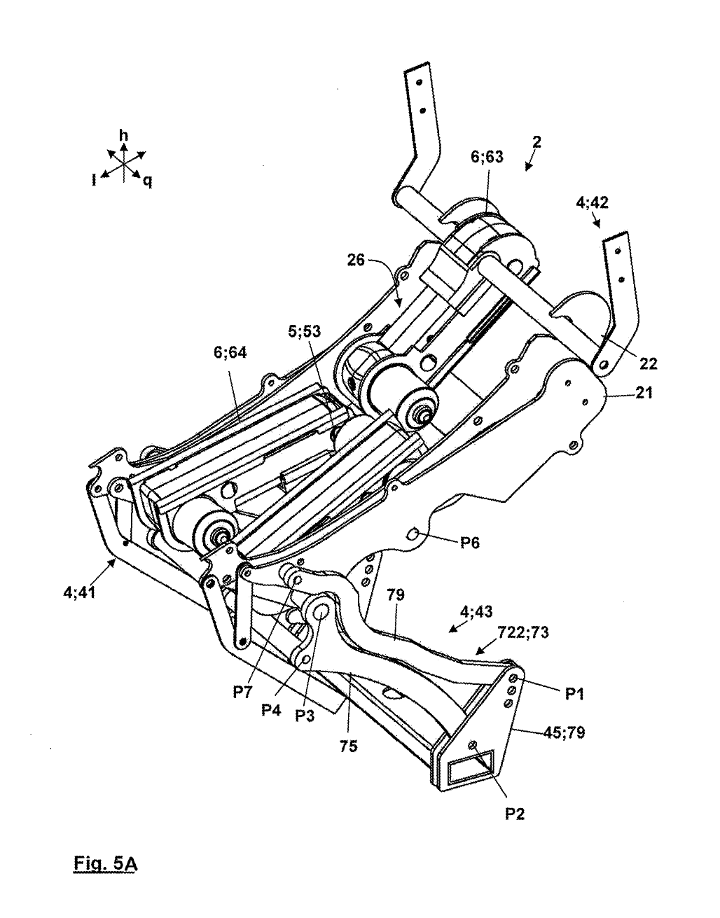

In addition to the foot portion 41 and the backrest portion 42 the seat fitting 3 shown in FIGS. 4 through 6 has a stand-up assist 43. The base unit 2 and therewith the seat frame 44 with the seat plane S can be lifted by means of the stand-up assist 43 and pivoted about a pivot axis s which is central with respect to the longitudinal direction 1, in which case the location of the pivot axis s is displaced during the lifting movement of the seat frame 44. To provide the stand-up assist 43, there is a base support 45 which is arranged relative to the base frame 21 in posterior relationship with respect to the sliding frame 22.

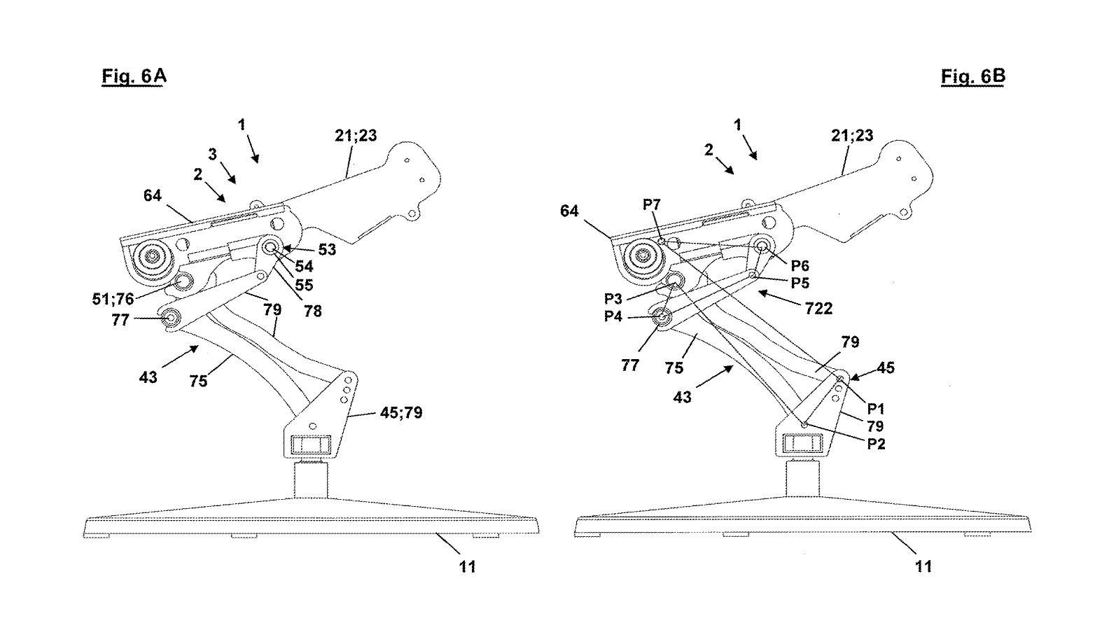

A further lever arrangement 73 is provided for displacement of the base frame 21 and therewith the seat frame 44, between the positions extended position and retracted position, the further lever arrangement 73 here being in the form of a seven-member planar second coupling transmission 722 and being driven by the stand-up assist linear drive 64 having the stand-up assist drive shaft 53. FIG. 6B shows the second coupling transmission 722 with its joint points P1-P7, wherein the broken lines connecting those joint points P1-P7 diagrammatically represent the transmission members. The joint points P1 and P2 at the base support 45 can be viewed as housing points which are static in relation to the movement. The levers operative between the joint points P1-P3 and P1 and P7 are respectively associated with the two base frame side portions 23. In that respect the term extended position is used to denote the stand-up position in which the base unit 2 is arranged displaced substantially in the heightwise direction h and in spaced relationship with respect to the base support 45. In principle a second coupling transmission 722 engages each base frame side portion 23, wherein same are then driven by way of the common stand-up assist drive shaft 53 by the same stand-up assist linear drive 64. Accordingly the movement of the coupling transmissions 722 occurs equally and synchronously.

A comparison of the coupling transmissions 721, 722 as shown in FIG. 3B and FIG. 6B shows that the two joint points G3 and P4 can coincide.

In FIG. 6, except for the support leg 11 of the article of seating furniture 1, all components of the article of seating furniture 1 or of the seat fitting 3, which cause difficulties or which are superfluous in terms of illustrating the function of the second coupling transmission 72 have been omitted. As can be seen from FIG. 6B, a three-point lever 75 extends from the joint point P2 and is mounted rotatably at the joint point P3 to the sliding frame drive shaft 51 here functioning as a transverse axis member 76, and engages a connecting axis member 77 at P4. Arranged non-rotatably on the stand-up assist drive shaft 53 is a radial lever 78 which is hingedly connected at the end to a lever 79 radially engaging the connecting axis member 77. That provides that the connecting axis member 77 is radially acted upon. A further lever 79 extends from the base support 45 approximately parallel to the three-point lever 75 to the associated base frame side portion 23 at which it is mounted pivotably at the joint point P7, the joint point P7 being concealed in FIG. 6B by the stand-up assist linear drive 53 disposed in front of same. Finally there is a further lever action as between the joint points P6 and P7.

Thus, the base frame is lifted in a complex planar pivotal movement, in which case the lever 79 is pressed radially against the transverse axis member 76 and the three-point lever 75 is displaced in respect of its longitudinal extent approximately axially relative to the lever 79.

In addition a rotation-arresting means not shown in greater detail in FIG. 6 is provided between the support leg 11 and the base support 45. The support leg 11 and the base support 45 are in particular held non-rotatably relative to each other when the stand-up assist is moved out of the retracted position in a direction towards the stand-up position.

The subject-matter of the present invention entails not only the subject-matter of the individual claims but also the combination of the individual claims with each other. All features and recitals disclosed in the documents—including the Abstract—, in particular the spatial configurations shown in the drawings, are claimed as essential to the invention insofar as they are novel individually or in combination over the state of the art.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1-15. (canceled)

16. A seat fitting for an article of seating furniture (1) comprising:
a base frame (21);
a sliding frame (22) moveably arranged relative to the base frame (21); and
at least one linear drive (6) which acts on an associated drive shaft (5) for reciprocal movement of a component or assembly of the seat fitting (3) including at least one of a foot portion (41), a backrest portion (42) or a stand-up assist (43) between an extended position and a retracted position relative to at least one of the base frame (21) and the sliding frame (22),
wherein the base frame (21), the sliding frame (22), the drive shaft (5) and the linear drive (6) form a functional base unit (2) modularly assembled into a complete seat fitting (3) having at least one of the foot portion (41), the backrest portion (42), the stand-up assist (43) and a seat frame (44) provided for the sliding frame (22).

17. The seat fitting of claim 16, wherein the drive shaft (5) serves as a transverse brace of at least one of the base and sliding frames (21, 22) of the base unit (2), and wherein the drive shaft (5) is rotatably mounted to said at least one of the base and sliding frames (21, 22).

18. The seat fitting of claim 16, wherein the base frame (21) has two base frame side portions (23) and a transverse reinforcement arranged therebetween, and the sliding frame (22) includes two sliding frame side portions (25) each movably mounted relative to the corresponding base frame (21) side portion.

19. The seat fitting of claim 18, wherein at least one of the base frame side portions (23) and the sliding frame side portions (25) are of a plate-shaped configuration defining a plane which extends transversely relative to a plane (S) of the article of seating furniture.

20. The seat fitting of claim 16, wherein the at least one linear drive (6) has a housing (61) through which the associated drive shaft (5) is guided and radially mounted, the housing (61) being configured to carry bending moments exerted on the drive shaft (5) by the linear drive (6).

21. The seat fitting of claim 18, wherein the at least one linear drive comprises at least one of:
a sliding frame linear drive (62) associated with the foot portion (41), acting on a sliding frame drive shaft (51),
a backrest linear drive (63) associated with the backrest portion (42), acting on a backrest drive shaft (52), and
a stand-up assist linear drive (64) associated with the stand-up assist (43), acting on a stand-up assist drive shaft (53).

22. The seat fitting of claim 21, wherein the sliding frame (22) is held pivotably to the base frame (21) at the sliding frame side portions (25) thereof by way of pivot levers (71).

23. The seat fitting of claim 22, wherein two pivot levers (71) are provided for each sliding frame side portion (25), the pivot levers (71), the sliding frame drive shaft (51) and the base frame side portion (23) forming a first coupling transmission (721) driven by the sliding frame drive shaft (51).

24. The seat fitting of claim 16, wherein the foot portion (41) is connected on one hand to the sliding frame (22) and on another hand to the base frame (21) via a scissor-like lever arrangement (73) at a first side (281) of the base unit (2), adjacent to the foot portion (41).

25. The seat fitting of claim 21, wherein the backrest drive shaft (52) of the backrest portion (42) is arranged at a second side (282) of the sliding frame (22), remote from the foot portion (41), the backrest portion (42) being non-rotatably connected to the backrest portion drive shaft (52).

26. The seat fitting of claim 16, wherein the stand-up assist (43) comprises a base support (45) which is arranged mounted in posterior relationship with the sliding frame (22) relative to the base frame (21), and that for extension and retraction of the base frame (21) together with the sliding frame (22) arranged between the base support (45) is a lever arrangement (73) for relative pivotal movement thereof.

27. The seat fitting of claim 26, wherein the lever arrangement (73) comprises a multi-member second coupling transmission (722).

28. The seat fitting of claim 16, wherein the base frame (21) defines a receiving space (26) in which at least one of the sliding frame (22) and the at least one linear drive (6) is arranged.

29. The seat fitting of claim 16, wherein the seat frame (44) defines a seat plane (S), and the seat frame (44) is arranged mounted to the sliding frame (22) above the sliding frame (22) in a heightwise direction (h).

30. The seat fitting of claim 29, wherein the seat plane (S) is at least one of pivoted and displaced by at least one of extension of the seat frame (44) which is connected to the sliding frame (22) and by way of the stand-up assist (43) about a pivot axis (s) which is arranged parallel to the transverse direction (q) of the seat fitting (3) and in a central region with respect to a longitudinal direction (l).

31. The seat fitting of claim 18, wherein the transverse reinforcement comprises one of a transverse member (24) or a transverse strut means.

32. The seat fitting of claim 19, wherein the plane of the at least one of the base frame side portions (23) and the sliding frame side portions (25) extends perpendicularly relative to the plane (S) of the article of seating furniture.

33. The seat fitting of claim 20, wherein the drive shaft (5) is radially-axially mounted through the housing (61).

34. The seat fitting of claim 27, wherein the multi-member second coupling transmission (722) is a seven-member second coupling transmission.
